(19) United States
(12) Patent Application Publication
(10) Pub. No.: US 2006/0232747 A1
(43) Pub. Date: Oct. 19, 2006

(54) Aerial display system

(75) Inventors: Curtis L. Thornton, Simi Valley, CA (US); Jeffrey L. Vrachan, Agoura Hills, CA (US)

Correspondence Address: Trellis Intellectual Property Law Group, PC, 1900 EMBARCADERO ROAD, SUITE 109, PALO ALTO, CA, 94303, US

(73) Assignees: Provision Interactive Technologies, Inc.,, Chatsworth, CA (US); a California Corporation

(21) Appl. No.: 11/105,857

(22) Filed: Apr. 14, 2005

(51) Int. Cl. G03B 21/00

(52) U.S. Cl. 353/7

(57) ABSTRACT

A aerial display system comprising inexpensive optical elements and a high brighted LCD display or similar video image display types provides floating images in an inexpensive enclosure. In the aerial display system, either an anti-reflective acrylic plastic layer or a circular polarizer is disposed proximate and parallel to a beam splitter so that the focal point of the floating image is proximate to the plastic layer or polarizer. This image position yields both a wider field of view and wider perceived field of view.

### CROSS REFERENCE TO RELATED APPLICATIONS

This application is related to commonly assigned provisional patent application entitled “Aerial Display System” by Curtis L. Thornton et al, application No. 60/568,145, filed May 5, 2004 the entire disclosure of which is herein incorporated by reference.

### BACKGROUND OF THE INVENTION

1. Field of the Invention

Embodiments of the present invention relate to aerial display system. More particularly, embodiments of the present invention relate to an optimized aerial display system for consumer display applications.

2. Description of the Background Art

Aerial display systems generate images that appear to float in the air several inches in front of the display device. Aerial display systems have been used for many years because of the novelty associated with a floating image.

Prior art aerial display systems are typically housed in a wooden structure that resembles a large box the size of a refrigerator. Inside the structure, a region for displaying static item is in optical alignment with optical components that generate an aerial image of the static item. By way of example, a shoe or a food item may be positioned in the display region to generate a floating image of the item. In some applications, the display region comprises a video display device, such as a cathode ray tube (CRT) or liquid crystal display (LCD) that generates a floating video image. The HOLOVISION™ display system, developed by Provision Entertainment, the assignee of the present application, provides realistic floating three-dimensional video images using a high bright LCD that achieves a very black background rather than a grayish black background. HOLOVISION is a trademark of Provision Entertainment.

Unfortunately, prior art aerial display systems require a very large form factor to achieve a realistic floating or aerial image, are very heavy and are very expensive. Thus, their use has been limited to commercial applications such as product demonstrations at conventions or trade shows or to display expensive objects such as jewelry or objects of museum quality.

Another problem with prior art aerial display systems arises from the expensive optical elements, specifically a beam splitter, a glass spherical mirror and a circular polarizer, that are used to generate the floating image. For example, the spherical mirror is typically an expensive highly polished glass substrate with low distortion that costs over a $1,000 for an average sized display unit. Further, while the polarizer prevents a viewer's reflection from polluting the floating image, it is also a very expensive element.

Because of the high cost of prior art aerial display systems, such systems have not been widely adopted by many businesses and even fewer consumer applications include an aerial projection display system. Indeed, prior art aerial display systems are limited to museums and trade show applications where the high cost of the system can be justified by its ability to attract attention. Clearly, what is needed is a low cost aerial projection system that can be used for consumer and business applications. For example, as home entertainment systems increase in popularity, the ability to project three-dimensional images toward the viewer enables realistic presentation of motion and perspective. Further, as interactive gaming achieves greater popularity, the ability to project three-dimensional objects from the computer display toward the viewer will enhance realism. Thus, there is great need for a low cost aerial display system that can be included as part of a home entertainment system, computer display or as part of an interactive gaming application, by way of example, rather than to limit the use of aerial projection systems to museums or trade show applications. What is also needed is an aerial projection system that can be used in both the home environment and in commercial applications in ambient lighting conditions. What is also needed is an aerial projection system that is lightweight and easily adapted to a variety of applications.

### SUMMARY OF EMBODIMENTS OF THE INVENTION

Embodiments of the present invention provide an improved aerial display system. More specifically, embodiments of the present invention include low cost optical components maintained in optical alignment in a low cost housing. The system has a wider apparent field of view and true three-dimensional effects from a flat projection panel. The present invention may be combined with or serve as a replacement for a wide variety of display applications such as a computer display, television or in a home entertainment center.

Embodiments of the present invention further provide a housing for an aerial display system that is aesthetically pleasing and that minimizes unwanted distortion of the floating image.

Embodiments of the present invention also further provide an aerial display system having a low cost glass mirror manufactured using slumped glass that is not precision polished but which, nonetheless, has low distortion. In another embodiment, a low cost plastic mirror manufactured from a diamond turned injection mold tool to maintain optical tolerances is provided to minimize cost of the aerial image device without visual degradation of the aerial image.

Embodiments of the present invention also further provide an aerial display system having a novel bracket for positioning the mirror in proper alignment with the flat projection panel.

Embodiments of the present invention also further provide an aerial display system that has an open display region that creates the optical impression that the floating image is not associated with the housing. More specifically, in this embodiment, the enclosure has an exposed beam splitter and polarizer without a hood or upper enclosure portion. The polarizer is positioned parallel and proximate to the beam splitter.

Embodiments of the present invention also further provide an aerial display system that includes a high definition display (HDD) that creates the optical impression for viewers that the floating image is a virtual three-dimensional image without glasses or distortion of the displayed image. In one preferred embodiment, the HDD is a high definition LCD or plasma display having at least 2000×2000 pixel resolution. In another preferred embodiment, the three-dimensional image is generated by an autostereoscopic display. In yet another embodiment, a high-brighted autostereoscopic display to compensate for bright ambient lighting conditions.

In one further preferred embodiment, the display system does not include a hood over the beam splitter and the circular polarizer is physically coupled to the beam splitter. This embodiment creates a three-dimensional television where the image appears to reside on the circular polarizer.

Embodiments of the present invention also further provide an aerial display system that includes means for dissipating heat generated by the highbrighted display device. In one embodiment, a heat sink is attached to the back of the display device to draw heat away from the light generating components. In another embodiment, the airflow is increased behind the display device functions to draw heat away from the light generating components. Regardless of the embodiment selected to cool the display electronics, minimizing heat fatigue increases the working life of the display device.

Embodiments of the present invention also further provide an aerial display system that is readily configurable to display either a static object in a first configuration or a video image in a second configuration. Importantly, the optical relationship between the displayed object or image is properly aligned with the optical components.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only and not by way of any limitation, wherein:

### BRIEF DESCRIPTION OF THE DRAWINGS

FIG. 1 is a perspective view of a display system in accordance with an embodiment of the present invention.

FIG. 2 is an exploded view of the display system of FIG. 1.

FIG. 3 is a front view of display system of FIG. 1.

FIG. 4 shows a side sectional view of the display system of FIG. 1 taken along section line A—A.

FIG. 5 is a schematic illustration of a preferred LCD display in accordance with the present invention.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

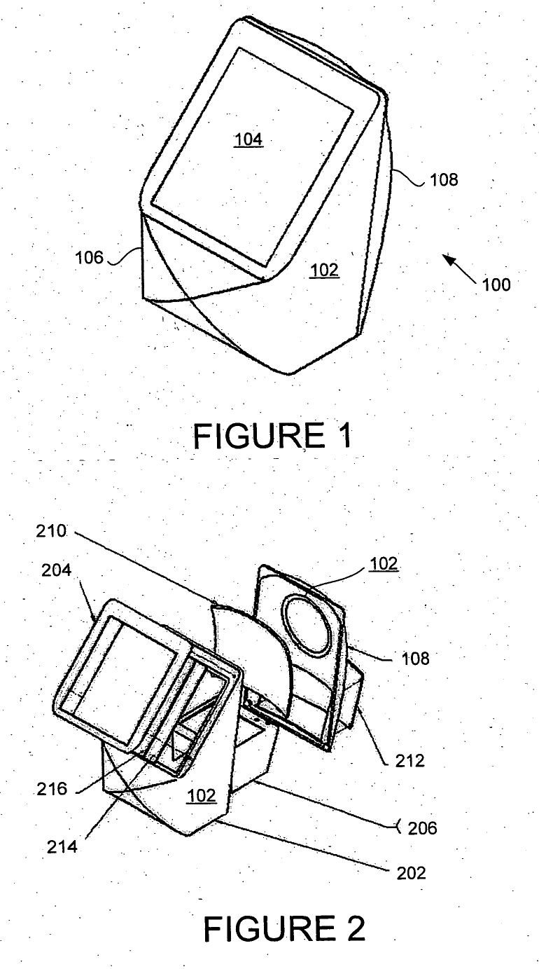

Referring now to the drawings more particularly by reference numbers, FIG. 1 shows a perspective view of a display system 100 in accordance with an embodiment of the present invention for generating aerial images of objects or video images. More specifically, aerial display system 100 has a generally oval-shaped enclosure 102 with a canted opening or window 104 through which the aerial image is projected. In one preferred embodiment, a display device, positioned in the lower portion 106 of system. 100, generates video images that appear as floating three-dimensional images. The display device may be a LCD panel, plasma display or other display connected to a video source and capable of generating bright images on a black background at video rates. A computer or other video sources such as DVD player, cable television signal and the like provides images for the display device.

In another embodiment, a static display shelf replaces the display device so that an item, such as a piece of jewelry, hamburger or a basketball shoe can be displayed as a static aerial image. The video source and the static display shelf may be interchangeably positioned in lower portion 106 through an opening in the back panel 108 of enclosure 100. The shelf properly positions the static object at the correct geometric coordinates for proper display of the object. When the shelf is removed, the LCD display slides and is supported by the shelf support bracket to maintain the optical relationship between the displayed object and the video image with the optical components.

It is important to note that the cant of window 104 enables the focal point to be moved back toward the window. The positioning of the image proximate to window 104 provides a wider viewing angle and makes this design well suited for retail applications were the viewer or viewers may not be ideally positioned in front of enclosure 100. Because there is no hood over or other light shield, it is preferred that the display device generate sufficient brightness to generate a bright, visible image in ambient lighting conditions.

In one embodiment, aerial display system 100 is coupled to a communication network by the computer system and a communication device (not shown) that may be any type of communication types including but not limited to the following communication types: hard wired via a dial up telephone line, wireless via cellular telephone or satellite, a Wi-Fi network connection or an Internet connection). System 100 may utilize the cellular telephone network to transfer information stored on the computer to a central location to record daily sales or viewer demographics.

FIG. 2 is an exploded view of aerial display system 100 of FIG. 1. Enclosure 102 comprises a base 202, a top frame 204 and back panel 108. Base 202 defines the volumetric region in which the video display device and computer 206 or shelf are positioned. The back panel 108 is attached to base 202 by a tongue and complimentary groove and least two spaced apart clasps. Base 202, frame 204 and panel 108 are lightweight molded plastic capable of retaining their shape under the load created by the weight of the optical components. Base 202 maintains the optical components in optical alignment at a low cost with a minimum of components.

Back panel 108 includes an annular rib 208 that supports a portion of generally rectangular-shaped spherical mirror 210. The side edges of mirror 210 contact interior edges of back panel 108 while the lower portion of rib 208 supports the center portion of mirror 210. Although not shown, a shelf or a pair of spaced-apart protrusions may further support the lower edge of mirror 210. Mirror 210 may be coupled to annular rib 208 and the shelf (or protrusions) by epoxy glue. The top edge of mirror 210 may contact or abut a top interior edge of back panel 108 to minimize movement of mirror should back panel be shipped with the mirror attached.

An optional access port 212 provides easy access to the interior of base 202 so that display device and computer 206 can be removed and an optional shelf inserted for static display of an object. In this manner, it is not necessary to remove the entire back panel but rather the access port 212 cover is removed, the display unit removed and the static shelf positioned. The shelf dimensions are selected so that the top support surface of shelf is at a lower level than the video display device. Thus, optical alignment between the static display object and the optical elements are maintained.

In addition to mirror 210, optical elements include a beam splitter 214 and either an anti-reflective coating 216. The anti-reflective acrylic plastic layer. The anti-reflective layer or coating may also be a polymer that is applied to the outward facing surface of the beam splitter and will stop external images from being reflected by the mirror.

In other embodiments, the anti-reflective layer is combined with a polarizer 216. The polarizer 216 is proximate to and aligned with the beam splitter 214. Preferably, polarizer 216 is coupled to the outer surface of beam splitter 214. Further, it is preferred that polarizer 216 is at linear polarizer with an anti-glare layer. In yet another embodiment, the polarizer is a circular polarizer without any anti-reflective coating. The beam splitter 214 and polarizer 216 are positioned in a recess of base 202 and retained therein by frame 204.

In one further preferred embodiment, the display system does not include a hood (or other light shield) over the beam splitter and polarizer 216 is a circular polarizer, which is aligned with the beam splitter, and is preferably physically coupled to the beam splitter. In this embodiment, the image appears to reside on the circular polarizer and gives the appearance of a three-dimensional television without projection of any image.

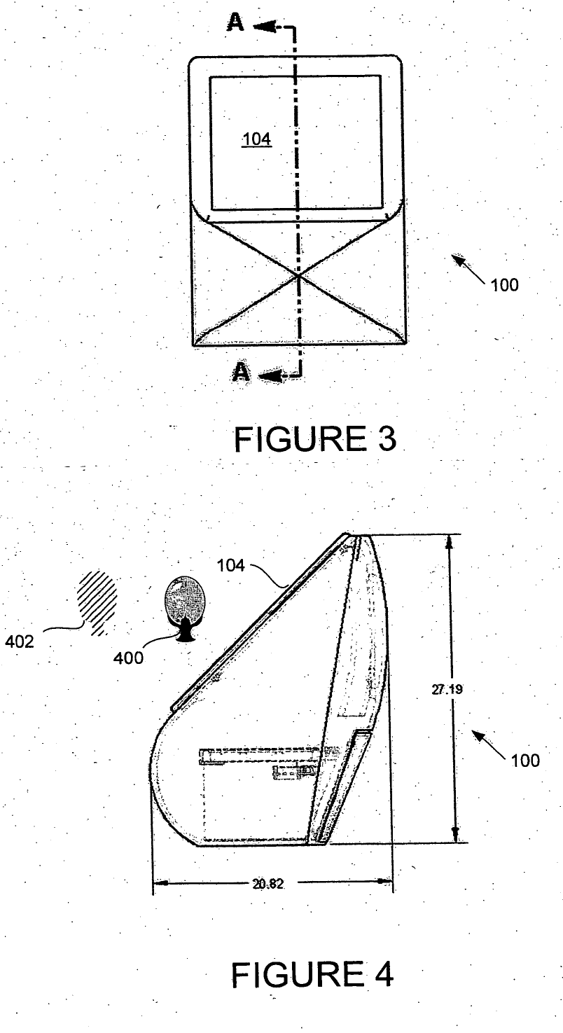

The frame 204, beam splitter 214 and polarizer 216 define window 104 through which aerial images are projected. As illustrated in FIG. 3, which is a front view of aerial display system 100, window 104 of about 20 inches in width is provided above the lower portion 106 of enclosure 102. A sectional side view of aerial display system 100 taken along the sectional line A-A of FIG. 3 is shown in FIG. 4 together with an illustration of an aerial image 400. Because the polarizer is aligned with and proximate to the beam splitter, it is possible to move the focal point, which is the point in space where the image is formed, toward the beam splitter. Thus, rather than having an image generated further out, such as is illustrated at 402, the ‘hoodless’ design of the present enclosure enables the projected image to be much closer to the beam splitter. This shorter focal distance enables a wider field of view and perhaps, more importantly, a perceived wider field of view.

The dimensions of aerial display system has, in one embodiment, a height dimension of about 27.19 inches, a width dimension of about 20 inches and a depth dimension of about 20.82 inches. In this embodiment, the LCD display panel is at least a 17-inch diagonal display device. In an alternative embodiment, a miniature aerial display system is scaled down by approximately fifty-five percent so that the height dimension is approximately 12 inches. The LCD display panel is a high bright 6-inch diagonal LCD display capable of projecting an image about six to ten inches in front of the beam splitter. The miniature system is an ideal desk-top unit for use with a standard LCD or plasma display.

Without a hood, it is critical that display device comprise a high bright LCD display or other similar bright video image generating display devices. In the present embodiment, the display device is coupled to computer 206 which functions as a video source although other alternative video sources can be employed. The high bright LCD display has a minimum luminance of about 1000 nits although a typical luminance of about 1500 to 1600 nits is preferred. To extend the life of the system, the high bright LCD display is initially set to a selected luminance sufficient to display the aerial image in ambient light and then increased as the display ages or degrades. The selected luminance level is selected based on environmental considerations. The high bright LCD display must also have a high contrast ratio (such as at least 400:1) so that images are vivid and visually attractive. To maintain the contrast ratio at high light conditions, the high bright LCD display will include a ZBEF filter.

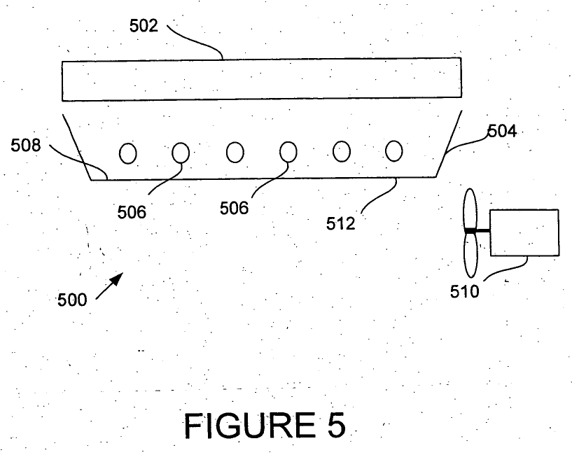

FIG. 5 is a schematic illustration of a LCD display 500. LCD display 300 comprises a LCD panel 502 and lighting fixture 504. Fixture 504 includes a plurality of light bulbs 506 and a reflector 508 on the inside surface of fixture 504. To minimize heat buildup, a fan 510 is mounted within about an inch of the back of the LCD display panel. A large heat sink 512 may also be coupled to the back-side of the panel to further minimize heat buildup. Alternatively, the back panel of the LCD display panel comprises an integral metal plate that functions to draw heat from the LCD panel. Thus, the effectiveness of the fan will be greatly increased. The cooler panel will have an extended life expectancy compared to a high bright LCD display panel without any cooling considerations.

Referring again to FIGS. 1-4, embodiments of the present invention that further includes a high definition display (HDD) instead of a high bright LCD display. HDD displays include LCD or plasma displays having at least 2000×2000 pixel resolution. The high resolution when combined with the optical elements of the aerial display system creates the optical impression for viewers that the floating image is a virtual three-dimensional image even if the image is two-dimensional. In yet another embodiment, the high bright LCD display is replaced by an autostereoscopic 3D display. In yet another embodiment, the autostereoscopic display is high brighted. As with the LCD display device, the computer or a DVD player, coupled to the display device generates video images for display.

Mirror 210 may be a low cost glass mirror manufactured using slumped glass that is not precision ground or polished but which, nonetheless, has low distortion. For example, the mirror 210 may be manufactured from the technology used to produce the common ‘makeup mirror’. By eliminating the grinding, the cost of the mirror is greatly reduced. However, the eyes of an observer will not tolerate a floating image that has wavy lines that are the results of imperfections in the mirror. Accordingly, it is necessary to ensure that the mold itself does not introduce the imperfections so a smooth mold surface is desired. A low cost glass mirror is achieved by using a high tolerance glass mold with limited surface defects (that is, in the range of one defect area per million areas.) The mold surface may be nickel or zinc or similar material that will not degrade by the high heat content of the glass as it is slumped in the mold. The mold may be made by a stereo-lithography technique to generate a mirror with no scratches or pits.

In another embodiment, a low cost plastic mirror manufactured from a diamond turned injection mold tool to maintain optical tolerances is provided to minimize cost of the aerial image device without visual degradation of the aerial image. Because a plastic mirror has a thermal coefficient, it is necessary that the fixture for positioning the mirror, that is the annular rib 208, have substantially identical thermal coefficients so that the mirror is retained in position and does not warp when subjected to several temperature cycles.

As used herein the term “computer” includes a system or mechanism that interprets and executes instructions (e.g., operating system code) and manages system resources. More particularly, a “computer” may accept, from computer readable medium, a program as input, prepares it for execution, and executes the process so defined with data to produce results. A “computer” may include an interpreter, a compiler and run-time system, or other mechanism, together with an associated host computing machine and operating system, or other mechanism for achieving the same effect. A “computer” may also include a central processing unit (CPU) that is a unit of a computing system that fetches, decodes and executes programmed instruction and maintains the status of results as the program is executed. A CPU is the unit of a computing system that includes the circuits controlling the interpretation of instruction and their execution.

A “computer program” or “operating system” may be any suitable program or sequence of coded instructions that are to be inserted into a computer, well known to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images.

A “computer-readable medium” for purposes of embodiments of the present invention may be any medium that can contain, store, communicate, propagate, or transport a program (e.g., a computer program) for use by or in connection with the instruction execution system, apparatus, system or device. The computer-readable medium can be, by way of example only but not by limitation, an electronic, magnetic, optical, electromagnetic, infrared, or semiconductor system, apparatus, system, device, propagation medium, or computer memory.

Reference throughout the specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A aerial display device comprising:
An enclosure having a lower portion, a back panel and a top frame;
Optical elements including a beam splitter in optical alignment with a spherical mirror and an anti-reflective acrylic plastic to stop reflections from reaching said mirror; said beam splitter and said anti-reflective acrylic plastic positioned in a recess of said enclosure and retained therein by said top frame;
A video source; and
A display device coupled to video source for displaying video images received from said video source, said display device positioned in said lower portion of said enclosure and in optical alignment with said optical elements such that an aerial display of said video images is displayed.

2. The aerial display device of claim 1 wherein said display device is a high brighted LCD display.

3. The aerial display device of claim 2 further comprising a cooling fan proximate to the back of said high brighted LCD display.

4. The aerial display device of claim 3 further comprising a heat sink positioned between said high brighted LCD display and said fan.

5. The aerial display device of claim 1 wherein said display device is an autosteroscopic display.

6. The aerial display device of claim 5 wherein said autosteroscopic display is high brighted.

7. The aerial display device of claim 6 wherein said high brighted autosteroscopic display has a contrast ratio of at least 400:1.

8. The aerial display device of claim 6 further comprising a cooling fan proximate bulb side of said high brighted autosteroscopic display.

9. The aerial display device of claim 8 further comprising a heat sink positioned between said high brighted autosteroscopic display and said fan.

10. The aerial display device of claim 1 wherein said display is a high definition display.

11. The aerial display device of claim 10 wherein said display is a high definition display has a contrast ratio of at least 400:1.

12. The aerial display device of claim 1 wherein said mirror is a slump glass mirror.

13. The aerial display device of claim 12 wherein said mirror has less than one surface area defect per million surface areas.

14. The aerial display device of claim 1 wherein said focal point is proximate to said anti-reflective acrylic plastic.

15. A aerial display device comprising:
An enclosure having a lower portion, a back panel and a top frame;
Optical elements including a beam splitter in optical alignment with a spherical mirror and a circular polarizer to stop reflections from reaching said mirror; said beam splitter and said circular polarizer positioned in a recess of said enclosure and retained therein by said top frame;
A video source; and
A display device coupled to video source for displaying video imagers received from said video source, said display device positioned in said lower portion of said enclosure and in optical alignment with said optical elements such that an aerial display of said video images is displayed.

16. The aerial display device of claim 15 wherein said focal point is proximate to said circular polarizer.

17. The aerial display device of claim 15 wherein said focal point substantially coincides with at least a portion of the plane defined by said circular polarizer.

18. The aerial display device of claim 15 wherein said display device is a high brighted LCD display.

19. The aerial display device of claim 18 further comprising a cooling fan proximate to the back of said highbrighted LCD display.

20. The aerial display device of claim 19 further comprising a heat sink positioned between said high brighted LCD display and said fan.

21. The aerial display device of claim 15 wherein said display device is an autosteroscopic display.

22. The aerial display device of claim 22 wherein said autosteroscopic display is high brighted.

23. The aerial display device of claim 23 wherein said high brighted autosteroscopic display has a contrast ratio of at least 400:1.

24. The aerial display device of claim 24 further comprising a cooling fan proximate bulb side of said high brighted autosteroscopic display.

25. The aerial display device of claim 25 further comprising a heat sink positioned between said high brighted autosteroscopic display and said fan.

26. The aerial display device of claim 15 wherein said display is a high definition display.

27. The aerial display device of claim 26 wherein said display is a high definition display has a contrast ratio of at least 400:1.

28. The aerial display device of claim 15 wherein said mirror is a slump glass mirror.

29. The aerial display device of claim 27 wherein said mirror has less than one surface area defect per million surface areas.

30. The aerial display device of claim 15 wherein said mirror is a plastic mirror.
